(19) United States
(12) Patent Application Publication
(10) Pub. No.: US 2025/0246356 A1
(43) Pub. Date: Jul. 31, 2025

(54) MULTILAYER COIL DEVICE

(71) Applicant: TDK CORPORATION, Tokyo (JP)

(72) Inventors: Kouichi KAKUDA, Tokyo (JP); Hidenobu UMEDA, Tokyo (JP); Shinichi SATO, Tokyo (JP); Kosuke ITO, Tokyo (JP); Youhei IIDA, Tokyo (JP); Yusuke NAGAI, Tokyo (JP); Keito YASUDA, Tokyo (JP)

(73) Assignee: TDK CORPORATION, Tokyo (JP)

(21) Appl. No.: 19/039,525

(22) Filed: Jan. 28, 2025

(30) Foreign Application Priority Data
Jan. 29, 2024 (JP) 2024-010842

(51) Int. Cl. H01F 27/255; H01F 1/20; H01F 27/28

(52) U.S. Cl. CPC H01F 27/255; H01F 1/20; H01F 27/2804; H01F 2027/2809

(57) ABSTRACT

A magnetic layer of a magnetic element body is between coil conductor layers in close proximity to each other along a lamination direction of the coil conductor layers. The magnetic layer includes metal magnetic particles. The metal magnetic particles have an average particle size of 0.3 μm or more and 2.5 μm or less. The metal magnetic particles provide a fill factor of 60% or more and 82% or less. The metal magnetic particles in a predetermined region, which contains a boundary between one of the coil conductor layers and the magnetic layer, have an average circularity of 0.80 or more.

### TECHNICAL FIELD

The present invention relates to a multilayer coil device that can be used as, for example, a multilayer inductor.

### BACKGROUND

Known is a multilayer inductor disclosed in, for example, Patent Document 1. In response to a demand for size reduction or the like of a multilayer coil device (e.g., the multilayer inductor), its magnetic layers between its coil conductor layers may be thinned. However, thinning the magnetic layers tends to reduce withstand voltage properties.

Also, from the viewpoint of improving inductance of the coil device, a multilayer body including the conductor layers and the magnetic layers may be pressed with high pressure to increase the percentage of metal magnetic particles included in the magnetic layers. However, the present inventors have found that pressing the multilayer body with high pressure increases variance in inductance.

Patent Document 1: JP Patent Application Laid Open No. 2013-38263

### SUMMARY

The present invention has been achieved in view of such circumstances. It is an object of the invention to provide multilayer coil devices having excellent withstand voltage properties and small variance in inductance.

The present inventors have diligently sought to achieve multilayer coil devices having excellent withstand voltage properties and small variance in inductance. The present inventors have found that such multilayer coil devices can be obtained by controlling the average particle size of their metal magnetic particles, fill factor of the metal magnetic particles, and average circularity of the metal magnetic particles located in a predetermined region of a magnetic layer in contact with a coil conductor layer within predetermined ranges and have finally achieved the present invention.

That is, a multilayer coil device according to one aspect of the present invention is a multilayer coil device including:
a magnetic element body; and
coil conductor layers laminated inside the magnetic element body so as to be connected continuously helically,
wherein
a magnetic layer of the magnetic element body is between the coil conductor layers in close proximity to each other along a lamination direction of the coil conductor layers;
the magnetic layer includes metal magnetic particles;
the metal magnetic particles have an average particle size of 0.3 μm or more and 2.5 μm or less;
the metal magnetic particles provide a fill factor of 60% or more and 82% or less; and
the metal magnetic particles in a predetermined region have an average circularity of 0.80 or more, the predetermined region extending from a boundary between one of the coil conductor layers and the magnetic layer.

Preferably, particle sizes of the metal magnetic particles have a CV of 30% or more and less than 50%. Such a structure further improves withstand voltage properties and reduces variance in inductance.

Preferably, the metal magnetic particles have an average particle size of 0.3 μm or more and 1.9 μm or less. Such a structure further improves withstand voltage properties.

Preferably, frequency in number of the metal magnetic particles having a particle size of 4.0 μm or more in a SEM image is 1.2% or less or may be 1.0% or less, 0.8% or less, or 0.6% or less. Such a structure further improves withstand voltage properties.

Preferably, the metal magnetic particles include an Fe based metal magnetic particle; the Fe based metal magnetic particle has an oxide film over a surface of the Fe based metal magnetic particle; and the oxide film contains a chemical element that oxidizes more readily than Fe. Such a structure further improves withstand voltage properties and reduces variance in inductance.

Preferably, the average circularity of the metal magnetic particles is calculated in the predetermined region which extends, in the magnetic layer, 0.2 times a distance between the coil conductor layers in close proximity to each other along the lamination direction.

### BRIEF DESCRIPTION OF THE DRAWING(S)

FIG. 1 is a perspective view of a multilayer coil device according to one embodiment of the present invention.

FIG. 2 is a schematic sectional view along a line II-II shown in FIG. 1.

FIG. 2A is an enlarged schematic sectional view of a magnetic layer between coil conductor layers shown in FIG. 2.

FIG. 2B is a view illustrative of metal magnetic particles in a predetermined region from a boundary between the magnetic layer and the corresponding coil conductor layer shown in FIG. 2A.

FIG. 2C is an illustrative view of interface side particles extracted from the metal magnetic particles shown in FIG. 2B.

FIG. 2D is an enlarged schematic sectional view of a magnetic layer between coil conductor layers according to another embodiment of the present invention.

FIG. 3A is an illustrative view of a method of manufacturing the multilayer coil device shown in FIG. 1.

FIG. 3B is an illustrative view of a step subsequent to the step shown in FIG. 3A.

FIG. 3C is an illustrative view of a step subsequent to the step shown in FIG. 3B.

FIG. 3D is an illustrative view of a step subsequent to the step shown in FIG. 3C.

FIG. 4 is a perspective view of a multilayer coil device according to still another embodiment of the present invention.

### DETAILED DESCRIPTION

Hereinafter, embodiments are described.

### First Embodiment

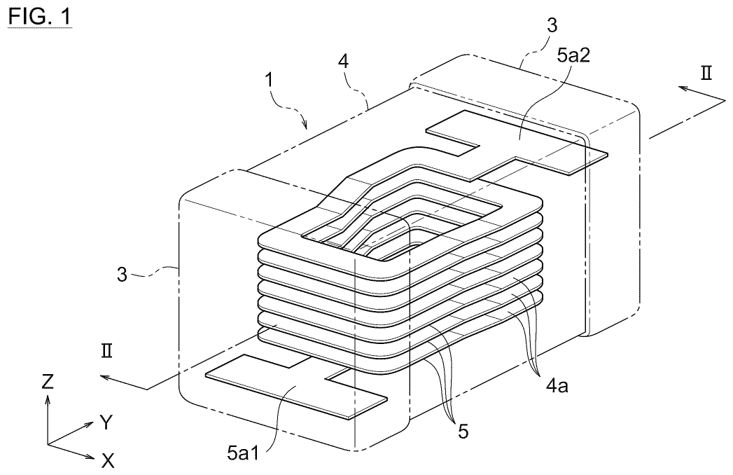

As an example coil-type electronic device according to the present embodiment, a multilayer coil device 1 shown in FIG. 1 is described below.

As shown in FIG. 1, the multilayer coil device 1 according to the present embodiment includes an element 2 and terminal electrodes 3. The element 2 has a structure in which coil conductor layers 5 are three-dimensionally and helically embedded in a magnetic element body 4. At both ends of the element 2, the terminal electrodes 3 are provided. These terminal electrodes 3 are connected to the coil conductor layers 5 via leading electrodes 5a1 and 5a2.

Note that, in FIG. 1 and other figures described later, the X-axis, the Y-axis, and the Z-axis are perpendicular to each other. Also note that, in the present embodiment, “inwards” means closer to a center of the multilayer coil device 1 (or an axis of the coil conductor layers 5), whereas “outwards” means farther from the center of the multilayer coil device 1.

The terminal electrodes 3 are made from any electrically conductive material. For example, Ag, Cu, Au, Al, a Ag alloy, or a Cu alloy may be used. In particular, Ag is preferably used for being inexpensive and having low resistance. The terminal electrodes 3 may contain glass frit. The terminal electrodes 3 may have a multilayer structure including a metal layer, which is provided on the element 2 and is composed of the above metal or is composed of the above metal and glass frit, and a resin layer, which is provided on the metal layer and is composed of a conductive resin.

The conductive resin may contain any metal. Examples of such metals include Ag. Surfaces of the terminal electrodes 3 may be plated. Examples of plating include Cu plating, Ni plating, Sn plating, Cu-Ni-Sn plating, and/or Ni-Sn plating as appropriate.

The coil conductor layers 5 and the leading electrodes 5a1 and 5a2 can be made from any electrically conductive material. For example, Ag, Cu, Au, Al, a Ag alloy, or a Cu alloy may be used. In particular, Ag is preferably used for being inexpensive and having low resistance. The coil conductor layers 5 may contain glass frit.

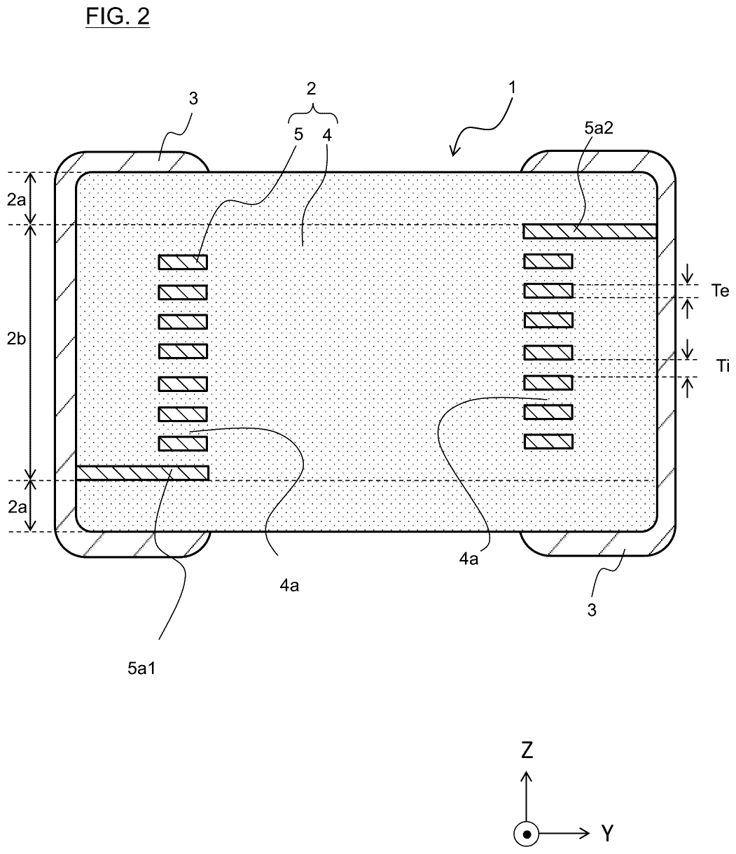

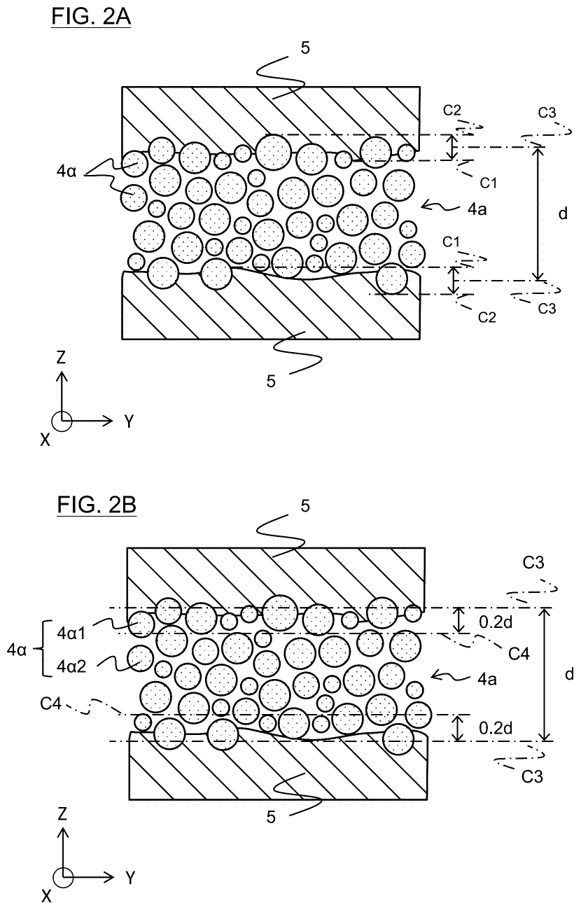

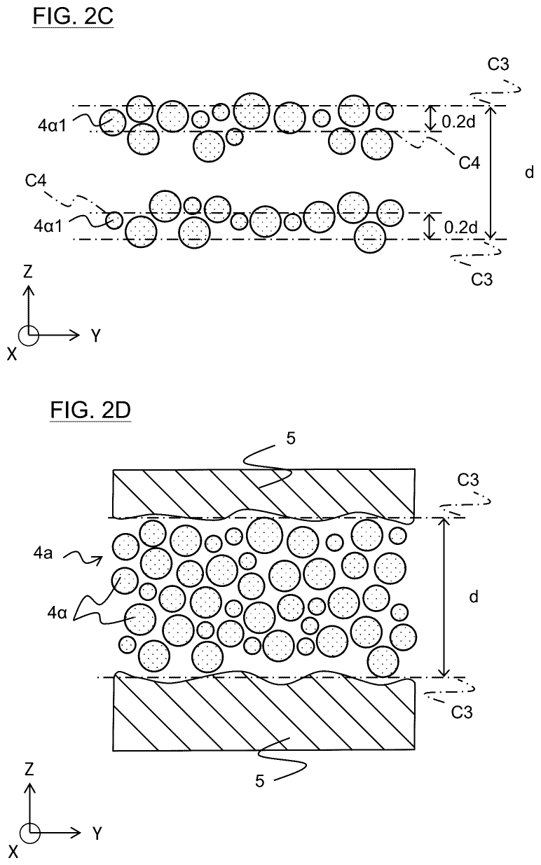

The number of turns of the coil conductor layers 5 around the axis is not limited and is, for example, 1.5 to 15.5. The coil conductor layers 5 shown in FIG. 2 may have any thickness Te. The thickness Te is, for example, 5 to 60 μm. Note that FIG. 2 is a schematic sectional view along a line II-II shown in FIG. 1 and shows a section parallel to Y-Z axes. That is, FIG. 2 is a sectional view in which the leading electrodes 5a1 and 5a2 and the terminal electrodes 3 are visible.

As shown in FIG. 2, the element 2 can be divided into, from below upwards along the winding axis (parallel to the Z-axis) of the coil conductor layers 5, an axial end region 2a, an axial center region 2b, and another axial end region 2a. In other words, the element 2 can be divided into the axial center region 2b, in which the coil conductor layers 5 are embedded, and the axial end regions 2a and 2a, which are located above and below the axial center region 2b along the axis direction (Z-axis direction) and do not have the coil conductor layers 5 embedded. Note that the axis direction of the coil conductor layers 5 is parallel to the lamination direction of the coil conductor layers 5.

Specifically, along the axis, outwards from imaginary lines that are perpendicular to the axis direction (Z-axis direction) and run along outer sides of the leading electrodes 5a1 and 5a2 are defined as the axial end regions 2a and 2a, whereas inwards from the imaginary lines is defined as the axial center region 2b. In the present embodiment, the axial center region 2b is a region including the leading electrodes 5a1 and 5a2.

In the present embodiment, a region of the element 2 between the coil conductor layers 5 next to each other in the axis direction is defined as an interlayer region 4a (a magnetic layer 4a). The magnetic layer 4a may have any thickness Ti (same as “interlayer thickness d” described later) along the Z-axis direction. The thickness can be as thin as, for example, 100 μm or less, 50 μm or less, 30 μm or less, 20 μm or less, 15 μm or less, 10 μm or less, 7 μm or less, or 4 μm or less.

As shown in FIG. 2A, the magnetic layer 4a includes metal magnetic particles 4a. The metal magnetic particles 4a may be made from any material. Examples of the material include Fe based metal magnetic particles (e.g., an Fe-Si based alloy, an Fe-Si-Cr based alloy, pure Fe, an Fe-Ni based alloy, an Fe-Si-Al based alloy, and an Fe-Co based alloy). Preferred is an Fe-Si based alloy. Note that the metal magnetic particles 4α may include metal particles other than these Fe based metal magnetic particles.

Provided that the total content of Fe and Si in the metal magnetic particles 4α is 100 mass %, the metal magnetic particles 4α have an Fe content of preferably 92.0 to 97.0 mass % or more preferably 92.5 to 96.5 mass %.

Provided that the total content of Fe and Si in the metal magnetic particles 4α is 100 mass %, the metal magnetic particles 4α have a Cr content of preferably 5 mass % or less, or more preferably less than 2 mass %. This ensures better balance between inductance and DC superimposition characteristics, further improves the results of evaluation of prevention of plating elongation, and further reduces the number of short circuits.

Provided that the total content of Fe and Si in the metal magnetic particles 4α is 100 mass %, the metal magnetic particles 4α may have a P content of 10 to 700 ppm or 40 to 650 ppm. This ensures better balance between inductance and DC superimposition characteristics, further improves the results of evaluation of prevention of plating elongation, and further reduces the number of short circuits.

As shown in FIG. 2B, the metal magnetic particles 4α, which are in between the coil conductor layers 5 and 5 in close proximity to each other along the Z-axis, can be classified into interface side particles 4α1 and center side particles 4α2. The interface side particles 4α1 are disposed within a predetermined region (0.2d) from a boundary C3 between the corresponding coil conductor layer 5 and the magnetic layer 4a. The center side particles 4α2 are the remaining particles. The boundary C3 between the coil conductor layer 5 and the magnetic layer 4a can be determined, for example, as follows.

For example, in a situation where the coil conductor layers 5 are formed using a printing method, some of the interface side particles 4α1, which are the metal magnetic particles 4α located inside the magnetic layer 4a and closer to the coil conductor layers 5, may dig into the coil conductor layers 5 during a manufacturing process. In such a situation, a boundary between the magnetic layer 4a and the corresponding coil conductor layer 5 is difficult to be identified in a sectional photograph of the magnetic layer 4a; however, the boundary C3 can be determined as follows.

First, as shown in FIG. 2A, through an image analysis of a section of the magnetic layer 4a using a SEM, a STEM, or the like, a mountaintop line C2 and a valley bottom line C1 are drawn. The mountaintop line C2 is a line that is in contact with a point of a particle most sunken into the coil conductor layer 5 in the sectional photograph and is perpendicular to the coil axis (Z-axis) direction. The valley bottom line C1 is a line that is in contact with a point of the coil conductor layer 5 closest to the magnetic layer 4a and is perpendicular to the coil axis (Z-axis) direction. A line in the middle of these lines is defined as the boundary C3.

Note that, for example, in a situation where the coil conductor layers 5 are formed by plating or the like, the metal magnetic particles 4α tend to be less sunken into the coil conductor layers 5 as shown in FIG. 2D; however, because the metal magnetic particles 4α are still slightly sunken into the coil conductor layers 5, the boundary C3 can be found similarly as in FIGS. 2A and 2B. Alternatively, the boundary C3 can be defined as a centerline (perpendicular to the Z-axis) of irregularities of a surface of the corresponding coil conductor layer 5 in contact with the magnetic layer 4a.

In any event, the interface side particles 4α1 can be defined as follows. As shown in FIG. 2B, the distance along the Z-axis between the boundaries C3 and C3, located between the coil conductor layers 5 and 5 which are close proximity to each other along the Z-axis, is defined as the thickness (interlayer thickness) d of the magnetic layer 4a. A distance 0.2d (the predetermined region) is defined by 0.2 times the thickness d. An imaginary line C4 parallel to the boundary C3 is drawn at a location that is inwardly away by the distance 0.2d from the corresponding boundary C3 towards a center of the magnetic layer 4a along the Z-axis. The particles that are in contact with or are included in the predetermined region between the boundary C3 and the imaginary line C4 at the location 0.2d away therefrom can be defined as the interface side particles 4α1, as are extracted as in FIG. 2C. Also, as shown in FIG. 2B, the metal magnetic particles 4α other than the interface side particles 4α1 can be defined as the center side particles 4α2.

In the present embodiment, the interface side particles 4α1 (some of the metal magnetic particles 4α), which are in the predetermined region (0.2d) from the boundary C3 between the coil conductor layer 5 and the magnetic layer 4a, have an average circularity of preferably 0.80 or more, 0.82 or more, or 0.84 or more. Such a range reduces variance in inductance and improves withstand voltage properties while high inductance is maintained.

Circularities of the interface side particles 4α1, which are extracted as shown in, for example, FIG. 2C using the method described above, can be found using, for example, the following mathematical formula. Circularity=4πS/L2

In the above formula, S denotes the projected area of the interface side particle 4α1 of interest, and L denotes the perimeter of the particle. The number of the interface side particles 4α1 (metal magnetic particles 4α) in close proximity to the corresponding coil conductor layer 5 and subject to an analysis of their circularities is preferably one hundred or more. In a situation where one field of view does not contain enough interface side particles 4α1, the analysis is carried out in preferably multiple fields of view.

The average circularity in the vicinity of the conductor can be controlled using, for example, circularity of a metal magnetic powder (raw material), pressure with which a multilayer body prior to firing is pressed, presence or absence of resin-rich buffer layers, whether a heat treatment of the metal magnetic powder before being turned into a paste is carried out, an increase or a decrease in the resin content of a magnetic layer paste, an increase or a decrease in the resin content of a conductor paste, a method of preparing a metal magnetic powder paste, or whether magnetic sheet layers are roll-pressed.

The metal magnetic particles 4α (hereinafter, 4α includes both 4α1 and 4α2 unless otherwise specified), which include both the interface side particles 4α1 and the center side particles 4α2 shown in FIG. 2B, have an average particle size of preferably 0.3 μm or more and 2.5 μm or less, or more preferably 0.3 μm or more and 1.9 μm or less. Compared to a situation where the average particle size is less than 0.3 μm, such a range of the average particle size of the metal magnetic particles 4α enables inductance to be increased, reduces variance in inductance, and improves withstand voltage properties. Compared to a situation where the average particle size is large, such a range of the average particle size of the metal magnetic particles 4α enables thinness (e.g., 10 μm or less) of the magnetic layer 4a to be maintained and inductance to be increased, reduces variance in inductance, and improves withstand voltage properties.

Any method of measuring the average particle size of the metal magnetic particles may be used. In the present embodiment, through an image analysis of a section of the magnetic layer 4a of the multilayer coil device 1 (electronic device) using a SEM, a STEM, or the like, the area of each metal magnetic particle 4α is calculated; a value (an area diameter) calculated as a diameter (an equivalent circle diameter) of a circle corresponding to that area is defined as the particle size of that metal magnetic particle 4α; and an average of particle sizes of multiple metal magnetic particles 4α is defined as the average particle size. Note that, with regard to the calculation of the average, the average of at least eight hundred metal magnetic particles 4α is found in a range where the magnetic layer 4a located between two coil conductor layers 5 and 5 next to each other is observed as shown in FIG. 2A and the at least eight hundred metal magnetic particles 4α are observed. In a situation where one field of view does not include eight hundred metal magnetic particles 4α, the analysis may be carried out in multiple fields of view.

The coefficient of variation (CV) showing variance in the particle sizes of the metal magnetic particles 4α is preferably 30% or more and less than 50%, more preferably 35% or more and less than 50%, or most preferably 40% or more and less than 50%. Too small a CV tends to impair packing properties and reduce the fill factor, whereas too large a CV tends to reduce the withstand voltage and increase variance in inductance. The CV can be found by finding the standard deviation under measurement conditions similar to those of finding the average particle size of the metal magnetic particles 4α and then multiplying a quotient of the standard deviation divided by the average particle size by 100.

Frequency in number of the metal magnetic particles 4α having a particle size of 4.0 μm or more is preferably 1.2% or less or may be 1.0% or less, 0.8% or less, or 0.6% or less. Such a structure further improves withstand voltage properties.

The metal magnetic particles 4α in the magnetic layer 4a provide a fill factor of preferably 60% or more and 82% or less. This range of the fill factor reduces variance in inductance and improves withstand voltage properties without letting inductance to decrease. Note that too low a fill factor tends to reduce inductance. Too high a fill factor tends to increase variance in inductance and impair withstand voltage properties. It is assumed that this is because high pressure applied to the element to increase the fill factor in a manufacturing process reduces the circularities of the metal magnetic particles located in the magnetic layer, particularly its portions near the coil conductor layers.

The fill factor is measured as follows. An image analysis of a section of the magnetic layer 4a is carried out using a SEM, a STEM, or the like. The total area of the metal magnetic particles 4α in a binary black and white image is calculated. The ratio of the area of the metal magnetic particles 4α to the area of the entire image is calculated and is defined as the fill factor. With regard to the calculation of the fill factor, particles at an edge of the sectional image are preferably included in the calculation. In a situation where the analysis is carried out in multiple fields of view from the viewpoint of the number of particles subject to an analysis of their particle sizes or circularities, an average fill factor may be adopted. Note that, with regard to the particle sizes, CV, and circularities, particles at an edge of the sectional image are preferably left out in the calculation.

The metal magnetic particles 4α may have their surfaces covered with a coating film. Specifically, the coating film is preferably an oxidized film. The oxidized film is preferably an oxide film containing a chemical element that oxidizes more readily than Fe. The oxidized film may include a layer composed of an oxide containing Si. The metal magnetic particles 4α being covered with the coating film enhances insulation among the metal magnetic particles 4α to improve Q factor. Also, the layer composed of the oxide containing Si in the oxidized film can prevent formation of an Fe oxide. Note that the metal magnetic particles 4α may be covered with a coating layer together with the oxidized film or may be covered with a coating layer other than the oxidized film.

A method of manufacturing the multilayer coil device 1 shown in FIG. 1 is described next. First, an example method of manufacturing the metal magnetic particles 4α is described.

In the present embodiment, as raw materials of the metal magnetic particles 4α, simple substances of the constituent elements or their alloys can be used. For example, simple substances of Fe, Si, Cr, Ni, Co, and Al can be used.

In the present embodiment, the metal magnetic particles 4α can be manufactured using a method similar to a known method of manufacturing the metal magnetic particles 4α. Specifically, the metal magnetic particles 4α can be manufactured using, for example, a gas atomization method, a water atomization method, or a rotating disk method. Among these methods, the gas atomization method is preferably used from the viewpoint of readily obtaining the metal magnetic particles 4α having a high circularity.

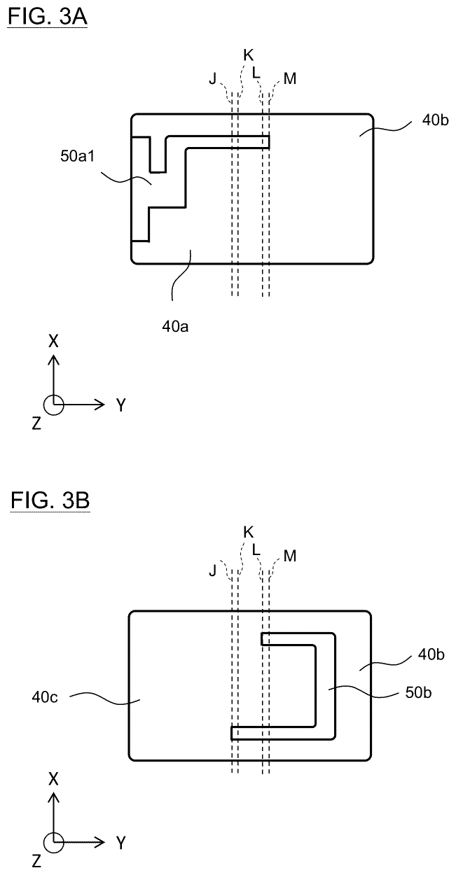

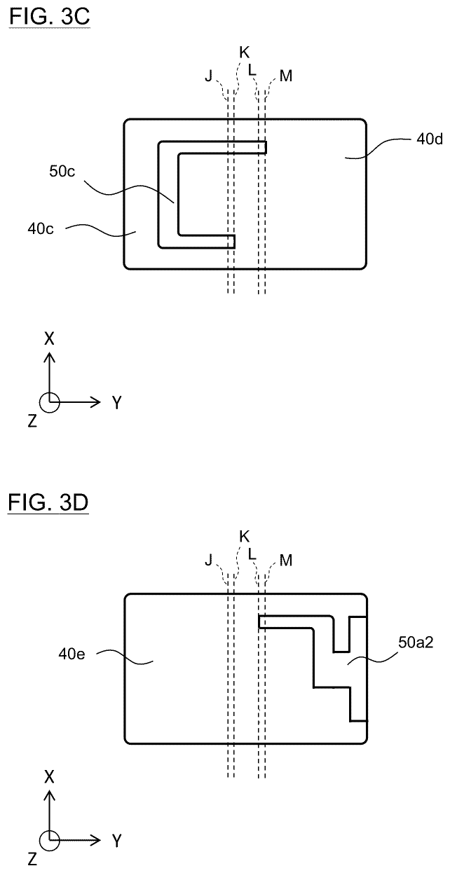

Then, the resultant metal magnetic particles 4α are turned into slurry together with additives (e.g., a solvent and a binder) to prepare a magnetic layer paste. Using this paste, magnetic sheet layers 40a to 40e shown in, for example, FIGS. 3A to 3D are formed. These magnetic sheet layers 40a to 40e are for constituting the magnetic layers 4a in the axial end regions 2a and the axial center region 2b shown in FIG. 2 after firing. As an organic vehicle, a mixture of a binder (e.g., a polyvinyl butyral based resin, an ethyl cellulose based resin, and an acrylic resin) and a solvent (e.g., terpineol and butyl carbitol) being mixed at a mixing ratio of, for example, 5 to 20:80 to 95 (based on mass) so that the magnetic layer paste has a freely-determined viscosity can be used. For example, for the organic vehicle of the magnetic layer paste, a polyvinyl butyral resin as a binder and butyl carbitol as a solvent may be used; and the mixing ratio of the binder to the solvent may be 10:90 (based on mass). Note that, as necessary, the magnetic layer paste may include additives selected from various dispersants, plasticizers, dielectrics, insulators, etc.

At the same time, or before or after the preparation of the magnetic layer paste, a conductor paste for forming the coil conductor layers 5 shown in FIGS. 1 and 2 is prepared. This conductor paste includes, together with additives (e.g., a solvent and a binder), metal for forming the coil conductor layers 5. For example, as for the composition of an organic vehicle of the conductor paste, an ethyl cellulose resin as a binder and terpineol as a solvent may be used; and the mixing ratio of the binder to the solvent may be 10:90 (based on mass). Note that, as necessary, the conductor paste may include additives selected from various dispersants, plasticizers, dielectrics, insulators, etc.

For example, to form the leading electrode 5a1 shown in FIGS. 1 and 2, on the magnetic sheet layer 40a shown in FIG. 3A, the magnetic sheet layer 40b is printed rightward from a dashed line J; and, using the printing method or the like, a conductor pattern layer 50a1 is formed so as to extend over a step between the magnetic sheet layers 40a and 40b.

Then, as shown in FIG. 3B, the magnetic sheet layer 40c is printed leftward from a dashed line L so that the conductor pattern layer 50a1 shown in FIG. 3A is mostly covered and only a portion of the conductor pattern layer 50a1 between the dashed line L and a dashed line M is exposed; and a conductor pattern layer 50b is formed thereon using the printing method or the like. Consequently, the conductor pattern layer 50a1 shown in FIG. 3A and the conductor pattern layer 50b shown in FIG. 3B are connected between the dashed lines L and M.

Then, as shown in FIG. 3C, the magnetic sheet layer 40d is printed rightward from a dashed line K so that the conductor pattern layer 50b shown in FIG. 3B is mostly covered and only a portion of the conductor pattern layer 50b between the dashed lines J and K is exposed; and a conductor pattern layer 50c is formed thereon using the printing method or the like. Consequently, the conductor pattern layer 50b shown in FIG. 3B and the conductor pattern layer 50c shown in FIG. 3C are connected between the dashed lines J and K.

Repeating the printing shown in FIG. 3B and the printing shown in FIG. 3C gives the conductor pattern layers corresponding to the coil conductor layers 5, which are helically wound multiple times as shown in FIG. 1, and the magnetic sheet layers corresponding to the magnetic layers 4a located therebetween.

At the last part of the helix, as shown in FIG. 3D, the magnetic sheet layer 40e is printed leftward from the dashed line L so that the conductor pattern layer 50c shown in FIG. 3C is mostly covered and only a portion of the conductor pattern layer 50c between the dashed lines L and M is exposed; and a conductor pattern layer 50a2 is formed thereon using the printing method or the like. Consequently, the conductor pattern layer 50c shown in FIG. 3C and the conductor pattern layer 50a2 shown in FIG. 3D are connected between the dashed lines L and M. The conductor pattern layer 50a2 is where to become the leading electrode 5a2 shown in FIGS. 1 and 2 after firing.

Further, using the magnetic layer paste, a portion constituting the axial end region 2a after firing is formed on the printed body shown in FIG. 3D using the printing method or the like. Note that, while the method of manufacturing the multilayer body using the printing method is described above, the multilayer body having the above structure can also be manufactured using a sheet method. Also, while the coil conductor layers 5 are formed using the printing method in this embodiment, a plating method may be used to form them.

In any event, the resultant multilayer body is pressed, for example, to increase the density of the metal magnetic particles 4α partway through lamination or after lamination. In the present embodiment, a step for increasing hardness of the metal magnetic particles 4α is preferably added prior to pressing. Alternatively, upper surfaces and/or lower surfaces of the conductor pattern layers 50a1, 50a2, and 50b to 50c may be provided with resin-rich buffer layers so that the circularities of the interface side particles 4α1 in the vicinity of the coil conductor layers 5 do not decrease even if the metal magnetic particles 4α come into contact with the coil conductor layers 5.

As a method of increasing hardness of the metal magnetic particles 4α, for example, a heat treatment of the metal magnetic particles prior to being turned into the paste is conceivable. The heat treatment may be carried out under any conditions. For example, the heat treatment can be carried out at 250 to 800° C. for 5 to 120 minutes in air or in an inert gas (e.g., nitrogen) containing a certain amount of oxygen (e.g., an oxygen partial pressure of 1% or less). Through the heat treatment, the oxidized film having a suitable thickness is formed.

As the resin-rich buffer layers, conceivable is forming buffer pattern layers containing only the resin and the solvent contained in the conductor pattern layers 50a1, 50a2, and 50b to 50c by printing, application, or the like before and/or after the conductor pattern layers 50a1, 50a2, and 50b to 50c are formed. Alternatively, conceivable is forming buffer pattern layers by printing, application, or the like before and/or after the conductor pattern layers 50a1, 50a2, and 50b to 50c are formed, using a paste whose organic vehicle content with respect to a soft magnetic metal powder is controlled so that the resin content is higher by 1 to 10 wt % than that of the conductor paste.

The resultant multilayer body is subject to a heat treatment (a binder removal step and a firing step) for removing the binder and giving the fired body (element 2). The binder removal step may be carried out at any holding temperature (binder removal temperature) at which the binder can be decomposed and removed as a gas. The binder removal temperature may be, for example, 300° C. or more and 450° C. or less. The binder removal step may be carried out for any amount of holding time (binder removal time). The binder removal time may be, for example, 0.5 hours or more and 2.0 hours or less.

The firing step may be carried out at any holding temperature (firing temperature) at which the metal magnetic particles constituting a soft magnetic metal powder connect with each other. The firing temperature may be 550° C. or more and 850° C. or less. The firing step may be carried out for any amount of holding time (firing time). The firing time may be 0.5 hours or more and 3.0 hours or less.

After firing, an annealing treatment (a heat treatment) may be carried out. The annealing treatment may be carried out under any conditions. The annealing treatment may be carried out, for example, at 500 to 800° C. for 0.5 to 2.0 hours. After the annealing treatment, any atmosphere may be used.

Then, on the element, the terminal electrodes 3 are formed. Any method of forming the terminal electrodes 3 may be used. Generally, a metal (e.g., Ag) that becomes the terminal electrodes 3 is turned into slurry together with additives (e.g., a solvent and a binder) for the formation.

The multilayer coil device 1 according to the present embodiment is manufactured using the method described above. Particularly in the present embodiment, the above efforts are preferably made to maintain the circularities of the metal magnetic particles 4α, particularly the interface side particles 4α1, shown in FIG. 2B.

### Second Embodiment

Hereinafter, a second embodiment is described. The second embodiment is similar to the first embodiment unless otherwise specified.

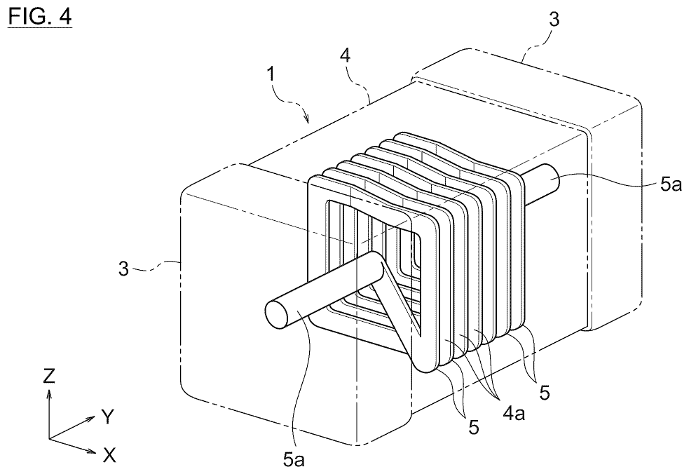

As shown in FIG. 4, a multilayer coil device 1 according to the present embodiment has a structure in which coil conductor layers 5 disposed inside a magnetic element body 4 are helically embedded in the magnetic element body 4 so as to have a Y-axis being a winding axis. At both ends of an element 2, terminal electrodes 3 are provided. These terminal electrodes 3 are connected to the coil conductor layers 5 via leading electrodes 5a and 5a. A section of a magnetic layer 4a located between the coil conductor layers 5 and 5 in close proximity to each other along the Y-axis inside the element 2 is similar to FIGS. 2A to 2D. While the winding axis of the coil is parallel to the Z-axis in the first embodiment, the winding axis of the coil is parallel to the Y-axis in the second embodiment. Also, while the lamination direction of the magnetic layers 4a is parallel to the Z-axis in the first embodiment, the lamination direction of the magnetic layers 4a is parallel to the Y-axis in the second embodiment.

While the embodiments of the present invention have been described above, the present invention is not at all limited to the above embodiments. The present invention may be modified into various forms without departing from the scope of the invention.

For example, while the multilayer coil devices exemplify coil-type electronic devices in the above embodiments, known coil-type electronic devices include, for example, transformers, choke coils, and coils. Also, while the coil-type electronic devices according to the above embodiments are suitably included in, for example, power supply circuits of various electronics (e.g., mobile devices) as inductors, impedance, etc., the coil-type electronic devices can be used for other purposes.

### EXAMPLES

Hereinafter, further detailed examples are described; however, the present invention is not limited to these examples.

### Example 1

Simple substances of Fe and Si in the form of an ingot, a chunk, or a shot (particles) were prepared so as to provide a 94Fe-6Si composition. They were mixed and were placed in a crucible disposed in a gas atomization apparatus. Subsequently, in an inert atmosphere, the crucible was heated to 1600° C. or more by high frequency induction using a work coil provided outside the crucible. The simple substances in the form of the ingot, chunk, or shot in the crucible were melted and were mixed to give a molten metal. Then, the molten metal was supplied from a nozzle of the crucible to form a linear continuous fluid and collided with a gas flowing at 1 to 10 MPa. The molten metal was formed into droplets, and at the same time, was quenched, dehydrated, dried, and classified. A resultant metal powder given by the above step was subject to a heat treatment at 300° C. for 30 minutes in air to provide a soft magnetic metal powder composed of Fe-Si based alloy particles. The soft magnetic metal powder had an average circularity of 0.89 measured with a static image analysis method.

The resultant soft magnetic metal powder (powder that became metal magnetic particles 4α included in magnetic layers 4a) was turned into slurry together with additives (e.g., a solvent and a binder) to prepare a magnetic layer paste. The magnetic layer paste contained 20 wt % organic vehicle with respect to 100 wt % soft magnetic metal powder. The organic vehicle in the magnetic layer paste was prepared by mixing a binder (polyvinyl butyral resin) and a solvent (butyl carbitol) at 10:90 (based on mass). Using this magnetic layer paste, magnetic sheet layers 40a to 40e shown in, for example, FIGS. 3A to 3D were formed with a printing method. These magnetic sheet layers 40a to 40e were for constituting the magnetic layers 4a in axial end regions 2a and an axial center region 2b shown in FIG. 2 after firing.

At the same time, or before or after the preparation of the magnetic layer paste, a conductor paste for forming coil conductor layers 5 shown in FIGS. 1 and 2 was prepared. The conductor paste contained Ag for forming the coil conductor layers 5 together with additives (e.g., a solvent and a binder). The conductor paste contained 20 wt % organic vehicle with respect to 100 wt % Ag particles. The organic vehicle in the conductor paste was prepared by mixing a binder (ethyl cellulose resin) and a solvent (terpineol) at 10:90 based on mass. Using this conductor paste, conductor pattern layers 50a1, 50b to 50c, and 50a2 shown in, for example, FIGS. 3A to 3D were formed with the printing method. These conductor pattern layers 50a1, 50b to 50c, and 50a2 were for constituting the coil conductor layers 5 shown in FIG. 2 after firing.

Through the steps shown in FIGS. 3A to 3D, a green multilayer body with a thickness of 0.8 mm was obtained. The coil conductor layers 5 were composed of a Ag conductor, and their number of turns was 7.5 Ts. Also, in order for circularities of interface side particles 4α1 in the vicinity of the coil conductor layers 5 shown in FIG. 2A to not decrease even if the metal magnetic particles 4α came into contact with the coil conductor layers 5, resin-rich buffer layers were formed on upper and lower surfaces of the conductor pattern layers 50a1, 50a2, and 50b to 50c using the printing method. As for the composition of a paste for forming the resin-rich buffer layers, 50 wt % organic vehicle containing a binder (ethyl cellulose resin) and a solvent (terpineol) mixed at a mixing ratio of 10:90 (based on mass) was added to 100 wt % Ag particles. The printing thickness of the resin-rich buffer layers was ½ to 1/20 of the thickness of a conductor paste film.

The green multilayer body obtained in this manner was cut into 1.6 mm×0.8 mm shapes to give green chips.

Then, the resultant green chips were subject to a binder removal treatment at 400° C. in an inert atmosphere (a N₂ gas atmosphere). After that, the chips were fired at 750° C. for 1 hour in a reducing atmosphere (a mixed gas atmosphere of a N₂ gas and a H₂ gas (hydrogen concentration: 1.0%)) to give fired chips.

On both end surfaces of each resultant fired chip, a terminal electrode paste was applied, and the paste was dried. A baking treatment was carried out at 700° C. for 1 hour in an atmosphere having an oxygen partial pressure of 1%. Then, electrolytic plating was carried out to form a Ni plating layer and a Sn plating layer on terminal electrodes. This formed the terminal electrodes 3 shown in FIG. 1 to give a multilayer coil device 1.

As for internal dimensions of the resultant multilayer coil device, the coil conductor layers 5 had a thickness (Te) of 20 μm shown in FIG. 2, and the magnetic layers 4a had a thickness (Ti) of 10 μm shown in FIG. 2.

The resultant multilayer coil device was subject to the following analyses.

### <Component Analysis>

Using elemental mapping photographs of the multilayer coil device of Example 1, its component analysis was carried out. According to the results of the analysis, it was confirmed that the magnetic layers 4a included the metal magnetic particles 4α having the same composition as that of the soft magnetic metal powder used as raw material. Further, it was confirmed that a 5 to 100 nm-thick oxide film composed of a Si oxide was observed on surfaces of the metal magnetic particles 4α.

### <SEM Image Analysis>

The coil device sample was cut in a plane perpendicular to the coil conductor layers, and the resultant section was wet-polished to give a polished surface. Then, the polished surface was subject to ion milling. A SEM image of the ion-milled polished surface of the chip's central part was observed.

Using image processing software (imageJ), a particle size distribution of equivalent circle diameters (Heywood diameters) of at least eight hundred metal magnetic particles 4α was obtained. When one field of view did not include eight hundred metal magnetic particles, multiple fields of view were observed. Based on the particle size distribution, the average particle size, CV, and number ratio of the particles having a particle size of 4.0 μbm or more (“≥4.0 μm frequency in number”) were calculated. Table 1 shows the results.

Through binarization or the like of the above SEM image, the ratio of the area of the metal magnetic particles 4α to the area of the entire image of the corresponding magnetic layer 4a was calculated and was defined as fill factor. Table 1 shows the results. Note that the fill factor was controlled using, for example, pressure with which the multilayer body prior to firing was pressed or the compositions of the pastes (resin content). The particle size distribution of the metal magnetic particles was controlled using, for example, classification of the metal magnetic powder (raw material) or mixing of metal magnetic powders having different particle size distributions.

### <Average Circularity in the Vicinity of Conductor>

With regard to a specific magnetic layer 4a in a field of view, boundaries C3 were found using the method described earlier. The distance between the boundaries C3 was defined as an interlayer thickness d. A distance that was 0.2 times the thickness d was defined as the distance 0.2d of a predetermined region. An imaginary line C4 parallel to the corresponding boundary C3 was drawn at a location that was inwardly away by the distance 0.2d from the boundary C3 towards a center of the magnetic layer 4a along the Z-axis. The particles that were in contact with or were included in the predetermined region between the boundary C3 and the imaginary line C4 at the location 0.2d away therefrom were defined as the interface side particles 4α1, as were extracted as in FIG. 2C.

In this example, circularities of the interface side particles 4α1, which were in the predetermined region (0.2d) from the boundary C3 between the corresponding coil conductor layer 5 and the magnetic layer 4a, were found using the image processing software (imageJ). Their average was defined as the average circularity in the vicinity of the conductor (average circularity of the interface side particles 4α1). Table 1 shows the results. Note that the average circularity in the vicinity of the conductor was controlled using, for example, circularity of the metal magnetic powder (raw material), pressure with which the multilayer body prior to firing was pressed, thickness of the resin-rich buffer layers, or the resin content.

### <Inductance Variance>

Inductance L of fifty inductor samples was measured using an RF impedance analyzer (E4991A manufactured by Keysight Technologies, Inc.) and a test fixture (16192A manufactured by Keysight Technologies, Inc.). As for measurement conditions, the measurement frequency was 10 MHz, and the measurement temperature was 25° C. Using the resultant data, (maximum value−minimum value)/average×100 was found as inductance variance (%). A variance of 10% or less was defined as very good and was indicated as “VG” in the Inductance variance column of each table. A variance of above 10% and 15% or less was defined as good and was indicated as “G” in the column. A variance of above 15% was defined as not good and was indicated as “NG” in the column. Table 1 shows the results.

### <Withstand Voltage>

Separately from the inductor samples, using similar materials and a similar method, capacitor samples were manufactured so that the thickness between electrode layers was the same as the thickness d between the coil conductor layers described above and that the number of the laminated conductor layers was 8 (close to 7.5 turns). The capacitor samples were subject to the following withstand voltage evaluation.

Using at least five capacitor samples, a voltage at which application of a direct voltage at 10 V per second to the samples resulted in a leakage current of 10 mA was measured. This voltage value was divided by the thickness between the conductor layers to give a quotient. The average of such quotients was defined as withstand voltage. A withstand voltage of 1.0 V/μm or more was defined as good. Table 1 shows the results.

### Examples 2 to 8

Samples were manufactured as in Example 1 except that the resin content of the magnetic layer paste and the molding pressure of multilayer bodies prior to firing were controlled so that the fill factor was as shown in Table 1. Evaluation was conducted as in Example 1. Table 1 shows the results.

### Comparative Example 1

Samples were manufactured as in Example 1 except that the resin content and the molding pressure were controlled so that the fill factor was less than 60%. Evaluation was conducted as in Example 1. In Comparative Example 1, it was not possible to evaluate the withstand voltage or inductance because the samples after firing had cracks. This is indicated by “-” in Table 1. The average circularity of the interface side particles 4α1 was evaluated using portions without cracks.

### Comparative Example 2

Samples were manufactured as in Example 1 except that the resin content and the molding pressure were controlled so that the fill factor exceeded 82%. Evaluation was conducted as in Example 1. Table 1 shows the results.

### Example 9

Samples were manufactured as in Example 1 except that raw materials were changed so that the composition of a soft magnetic metal powder was 85Fe-9.5Si-5.5Al and that the resin content and the molding pressure were controlled so that the fill factor was 68%. Evaluation was conducted as in Example 1. Table 1 shows the results.

### Example 10

Samples were manufactured as in Example 1 except that raw materials were changed so that the composition of a soft magnetic metal powder was 49Fe-42Ni-3Si-6Co and that the resin content and the molding pressure were controlled so that the fill factor was 70%. Evaluation was conducted as in Example 1. Table 1 shows the results.

TABLE 1

| | | Average | | ≥4.0 μm frequency | | Average circularity in | Withstand | |
|---|---|---|---|---|---|---|---|---|
| | | particle size | CV | in number | Fill factor | vicinity of conductor | voltage | Inductance |
| | Material | μm | % | % | % | — | V/μm | variance |
| Comparative Example 1 | FeSi | 1.4 | 49 | 0.1 | 55 | 0.82 | — | — |
| Example 1 | FeSi | 1.4 | 48 | 0.1 | 60 | 0.82 | 2.3 | VG |
| Example 2 | FeSi | 1.4 | 47 | 0.1 | 62 | 0.82 | 2.2 | VG |
| Example 3 | FeSi | 1.4 | 44 | 0.1 | 68 | 0.82 | 2.4 | VG |
| Example 4 | FeSi | 1.4 | 46 | 0.1 | 72 | 0.82 | 2.1 | VG |
| Example 5 | FeSi | 1.4 | 45 | 0.1 | 75 | 0.82 | 2.3 | VG |
| Example 6 | FeSi | 1.4 | 49 | 0.1 | 77 | 0.82 | 2.1 | VG |
| Example 7 | FeSi | 1.4 | 46 | 0.1 | 80 | 0.82 | 1.9 | VG |
| Example 8 | FeSi | 1.4 | 45 | 0.1 | 82 | 0.82 | 1.5 | VG |
| Comparative Example 2 | FeSi | 1.4 | 45 | 0.1 | 85 | 0.78 | 0.7 | NG |
| Example 9 | FeSiAl | 1.4 | 48 | 0.1 | 68 | 0.82 | 2.5 | VG |
| Example 10 | FeNiSiCo | 1.4 | 44 | 0.1 | 70 | 0.82 | 2.1 | VG |

### Evaluation 1

According to the results shown in Table 1, it was found that a fill factor of 60% or more and 82% or less improved the withstand voltage and reduced variance in inductance. It was found that, in Comparative Example 2, in which the interface side particles 4α1 had a low average circularity, the withstand voltage was lower and variance in inductance was larger than those of Examples 1 to 8. Comparison between Examples 9 and 10 and Examples 1 to 8 indicated that, independently of the composition of the metal magnetic particles 4α, a fill factor of 60% or more and 82% or less and an average circularity of the interface side particles 4α1 of 0.80 or more improved the withstand voltage and reduced variance in inductance.

### Examples 11 to 17

Samples were manufactured as in Example 1 except that manufacturing conditions or classification conditions of a soft magnetic metal powder (raw material) were controlled so that the average particle size (metal magnetic particles 4α) was as shown in Table 2 and that the resin content and the molding pressure were controlled so that the fill factor was 70%. Evaluation was conducted as in Example 1. Table 2 shows the results.

### Example 18

Manufacturing conditions or classification conditions of a soft magnetic metal powder (raw material) were controlled so that the average particle size (metal magnetic particles 4α) was 2.5 μm and the CV was 31% as shown in Table 2. At this time, the number ratio of the metal magnetic particles having a particle size of 4.0 μm or more was 0.3%. Then, samples were manufactured as in Example 1 except that the resin content and the molding pressure were controlled so that the fill factor was 68%. Evaluation was conducted as in Example 1. Table 2 shows the results.

### Comparative Example 3

Samples were manufactured as in Example 1 except that manufacturing conditions or classification conditions of a soft magnetic metal powder (raw material) were controlled so that the average particle size (metal magnetic particles 4α) was less than 0.3 μm and that the resin content and the molding pressure were controlled so that the fill factor was 62%, as shown in Table 2. Evaluation was conducted as in Example 1. Table 2 shows the results.

In Comparative Example 3, the fill factor was increased only to 62% even with an increased molding pressure. Also, it was not possible to evaluate the withstand voltage or inductance because the samples after firing had cracks. This is indicated by “-” in Table 2. The average circularity of the interface side particles 4α1 was evaluated using portions without cracks.

### Comparative Example 4

Manufacturing conditions or classification conditions of a soft magnetic metal powder (raw material) were controlled so that the average particle size (metal magnetic particles 4α) exceeded 2.5 μm and the CV was 27% as shown in Table 2. At this time, the number ratio of the metal magnetic particles having a particle size of 4.0 μm or more was 0.7%. Then, samples were manufactured as in Example 18 except that the resin content and the molding pressure were controlled so that the fill factor was 64%. Evaluation was conducted as in Example 18. Table 2 shows the results.

In Comparative Example 4, it was not possible to evaluate the withstand voltage or inductance because the samples after firing had short circuits. This is indicated by “-” in Table 2.

TABLE 2

| | | Average | | ≥4.0 μm frequency | Fill | Average circularity in | Withstand | |
|---|---|---|---|---|---|---|---|---|
| | | particle size | CV | in number | factor | vicinity of conductor | voltage | Inductance |
| | Material | μm | % | % | % | — | V/μm | variance |
| Comparative Example 3 | FeSi | 0.1 | 49 | 0 | 62 | 0.84 | — | — |
| Example 11 | FeSi | 0.3 | 48 | 0 | 70 | 0.84 | 2.9 | VG |
| Example 12 | FeSi | 0.6 | 46 | 0.1 | 70 | 0.84 | 2.6 | VG |
| Example 13 | FeSi | 0.8 | 49 | 0.1 | 70 | 0.84 | 2.6 | VG |
| Example 14 | FeSi | 1.3 | 48 | 0.1 | 70 | 0.84 | 2.5 | VG |
| Example 15 | FeSi | 1.5 | 45 | 0.1 | 70 | 0.84 | 2.3 | VG |
| Example 16 | FeSi | 1.9 | 46 | 0.1 | 70 | 0.84 | 2.0 | VG |
| Example 17 | FeSi | 2.2 | 42 | 0.1 | 70 | 0.84 | 1.4 | VG |
| Example 18 | FeSi | 2.5 | 31 | 0.3 | 68 | 0.84 | 1.1 | VG |
| Comparative Example 4 | FeSi | 2.8 | 27 | 0.7 | 64 | 0.84 | — | — |

### Evaluation 2

According to the results shown in Table 2, it was found that an average particle size of the metal magnetic particles 4α of 0.3 μm or more and 2.5 μm or less improved the withstand voltage and reduced variance in inductance. In particular, it was confirmed that an average particle size of the metal magnetic particles 4α of 2.2 μm or less, 2.0 μm or less, 1.9 μm or less, 1.5 μm or less, 1.3 μm or less, 1.0 μm or less, or 0.8 μm or less improved the withstand voltage.

In Comparative Example 3, in which the average particle size was small, it was found that the fill factor was not increased and that cracks tended to be generated during firing compared to Examples. In Comparative Example 4, in which the average particle size was large, it was found that short circuits of the multilayer coil devices tended to occur compared to Examples.

### Examples 19 to 24

Samples were manufactured as in Example 3 except that the thickness of the resin-rich buffer layers or the resin content was changed so that the average circularity of the interface side particles 4α1 varied from 0.80 and above. Evaluation was conducted as in Example 3. Table 3 shows the results.

### Comparative Example 5

Samples were manufactured as in Example 24 except that no resin-rich buffer layer was provided. Evaluation was conducted as in Example 24. Table 3 shows the results.

TABLE 3

| | | Average | | ≥4.0 μm frequency | | Average circularity in | Withstand | |
|---|---|---|---|---|---|---|---|---|
| | | particle size | CV | in number | Fill factor | vicinity of conductor | voltage | Inductance |
| | Material | μm | % | % | % | — | V/μm | variance |
| Example 19 | FeSi | 1.4 | 44 | 0.1 | 68 | 0.87 | 2.7 | VG |
| Example 20 | FeSi | 1.4 | 47 | 0.1 | 68 | 0.86 | 2.4 | VG |
| Example 21 | FeSi | 1.4 | 45 | 0.1 | 68 | 0.85 | 2.5 | VG |
| Example 22 | FeSi | 1.4 | 46 | 0.1 | 68 | 0.83 | 2.3 | VG |
| Example 3 | FeSi | 1.4 | 44 | 0.1 | 68 | 0.82 | 2.4 | VG |
| Example 23 | FeSi | 1.4 | 48 | 0.1 | 68 | 0.81 | 1.8 | VG |
| Example 24 | FeSi | 1.4 | 49 | 0.1 | 68 | 0.80 | 1.3 | VG |
| Comparative Example 5 | FeSi | 1.4 | 50 | 0.1 | 68 | 0.78 | 0.8 | NG |

### Evaluation 3

According to the results shown in Table 3, it was found that an average circularity of the interface side particles 4α1 of 0.80 or more improved the withstand voltage and reduced variance in inductance.

### Examples 25 to 29

Samples were manufactured as in Example 22 except that classification conditions or the like of a soft magnetic metal powder (raw material) were controlled so as to control the number ratio of the metal magnetic particles having a particle size of 4.0 μm or more. Evaluation was conducted as in Example 22. Table 4 shows the results.

TABLE 4

| | | Average | | ≥4.0 μm frequency | Fill | Average circularity in | Withstand | |
|---|---|---|---|---|---|---|---|---|
| | | particle size | CV | in number | factor | vicinity of conductor | voltage | Inductance |
| | Material | μm | % | % | % | — | V/μm | variance |
| Example 22 | FeSi | 1.4 | 46 | 0.1 | 68 | 0.83 | 2.3 | VG |
| Example 25 | FeSi | 1.4 | 46 | 0.4 | 68 | 0.84 | 1.9 | VG |
| Example 26 | FeSi | 1.4 | 47 | 0.6 | 68 | 0.84 | 1.6 | VG |
| Example 27 | FeSi | 1.4 | 49 | 0.8 | 68 | 0.83 | 1.4 | VG |
| Example 28 | FeSi | 1.4 | 49 | 1.0 | 68 | 0.83 | 1.2 | VG |
| Example 29 | FeSi | 1.4 | 59 | 1.2 | 68 | 0.82 | 1.0 | G |

### Evaluation 4

According to the results shown in Table 4, it was confirmed that the number ratio of the metal magnetic particles having a particle size of 4.0 μm or more being 1.2% or less, 1.0% or less, 0.8% or less, or 0.6% or less improved withstand voltage properties even if the CV was not lower than a predetermined value (e.g., 37% or more, or 40% or more).

### Examples 30 to 32

Samples were manufactured as in Example 3 except that classification conditions or the like of a soft magnetic metal powder (raw material) were changed so as to control the CV. Evaluation was conducted as in Example 3. Table 5 shows the results.

TABLE 5

| | | Average | | ≥4.0 μm frequency | Fill | Average circularity in | Withstand | |
|---|---|---|---|---|---|---|---|---|
| | | particle size | CV | in number | factor | vicinity of conductor | voltage | Inductance |
| | Material | μm | % | % | % | — | V/μm | variance |
| Example 30 | FeSi | 1.4 | 30 | 0.1 | 62 | 0.82 | 2.4 | VG |
| Example 31 | FeSi | 1.4 | 35 | 0.1 | 65 | 0.82 | 2.5 | VG |
| Example 32 | FeSi | 1.4 | 40 | 0.1 | 68 | 0.82 | 2.4 | VG |
| Example 3 | FeSi | 1.4 | 44 | 0.1 | 68 | 0.82 | 2.4 | VG |
| Example 23 | FeSi | 1.4 | 48 | 0.1 | 68 | 0.81 | 1.8 | VG |
| Example 24 | FeSi | 1.4 | 49 | 0.1 | 68 | 0.80 | 1.3 | VG |

### Evaluation 5

According to the results shown in Table 5, it was confirmed that reducing the CV improved the withstand voltage. Note that a CV of less than 30% may increase manufacturing costs for processing (e.g., advanced classification).

### REFERENCE NUMERALS

1 . . . multilayer coil device
2 . . . element
2a . . . axial end region
2b . . . axial center region
3 . . . terminal electrode
4 . . . magnetic element body
4a . . . magnetic layer
4α . . . metal magnetic particle
4α1 . . . interface side particle
4α2 . . . center side particle
40a to 40e . . . magnetic sheet layer
5 . . . coil conductor layer
5a1, 5a2, 5a . . . leading electrode
50a1, 50a2, 50b to 50c . . . conductor pattern layer

What is claimed is:

1. A multilayer coil device comprising:
a magnetic element body; and
coil conductor layers laminated inside the magnetic element body so as to be connected continuously helically,
wherein
a magnetic layer of the magnetic element body is between the coil conductor layers in close proximity to each other along a lamination direction of the coil conductor layers;
the magnetic layer comprises metal magnetic particles;
the metal magnetic particles have an average particle size of 0.3 μm or more and 2.5 μm or less;
the metal magnetic particles provide a fill factor of 60% or more and 82% or less; and
the metal magnetic particles in a predetermined region have an average circularity of 0.80 or more, the predetermined region extending from a boundary between one of the coil conductor layers and the magnetic layer.

2. The multilayer coil device according to claim 1, wherein particle sizes of the metal magnetic particles have a CV of 30% or more and less than 50%.

3. The multilayer coil device according to claim 1, wherein the metal magnetic particles have an average particle size of 0.3 μm or more and 1.9 μm or less.

4. The multilayer coil device according to claim 1, wherein frequency in number of the metal magnetic particles having a particle size of 4.0 μm or more in a SEM image is 1.2% or less.

5. The multilayer coil device according to claim 1, wherein
the metal magnetic particles comprise an Fe based metal magnetic particle;
the Fe based metal magnetic particle has an oxide film over a surface of the Fe based metal magnetic particle; and
the oxide film comprises a chemical element that oxidizes more readily than Fe.

6. The multilayer coil device according to claim 1, wherein the average circularity of the metal magnetic particles is calculated in the predetermined region which extends, in the magnetic layer, 0.2 times a distance between the coil conductor layers in close proximity to each other along the lamination direction.
